(19) United States
(12) Patent Application Publication
(10) Pub. No.: US 2011/0044060 A1
(43) Pub. Date: Feb. 24, 2011

(54) INFRA-RED RADIATION DEVICE

(75) Inventors: Martin Klinecky, Gelnhausen (DE); Jochen Simon, Freigericht-Neuses (DE); Sven Linow, Darmstadt (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Heraeus Noblelight GmbH, Hanau (DE)

(21) Appl. No.: 12/294,465

(22) PCT Filed: Mar. 27, 2007
(86) PCT No.: PCT/EP2007/002726

§ 371 Date: Aug. 6, 2010

(30) Foreign Application Priority Data
Mar. 28, 2006 (DE) 10 2006 014 689.1

(51) Int. Cl. F21V 7/20; F21V 7/22

(52) U.S. Cl. 362/345; 362/341

(57) ABSTRACT

A high-power radiation module has thermal protection made of inorganic, oxidic material arranged between the radiator and housing. The thermal protection is made of an essentially fiber-free material that is optically inhomogeneous with respect to IR radiation and/or UV radiation The high-power radiation module has a power per unit contact area of at least 200 kW/m². The use of a radiation module and a method for the production of a radiation module include radiators or radiation units connected electrically and held mechanically in a housing having an outlet opening for the emitted radiation.

### CROSS-REFERENCE TO RELATED APPLICATIONS

This application is a Section 371 of International Application No. PCT/EP2007/002726, filed Mar. 27, 2007, which was published in the German language on Oct. 11, 2007, under International Publication No. WO 2007/112896 A1 and the disclosure of which is incorporated herein by reference.

### BACKGROUND OF THE INVENTION

The present invention relates to high-power radiation modules, in particular NIR modules. Such modules are surface radiators and typically contain at least two infrared radiators arranged in parallel next to each other and have a single round tube or a double tube. For modules having a power per unit surface area up to 150 kW/m², air-cooled gold reflectors are suitable, in order to focus the radiation onto the object to be irradiated. Powers per unit contact area of 200 kW/m² and above can be realized only with water-cooled reflectors, because the reflectors would otherwise be destroyed very quickly due to overheating. Such modules provided with additional water cooling are known from German published patent applications DE 101 56 915 A1 and DE 101 25 888 A1.

Complicated water cooling is not desired in electrical systems. First due to the additional costs and second because there is always the risk of water leakage. On the one hand, water leakage can damage the products to be irradiated and, on the other hand, can have disastrous effects on the electrical devices or the hot parts of the system. Therefore, from the viewpoint of operational safety, water is an extremely undesirable medium.

In DE 101 56 915 A1, ceramic fiber plates are also disclosed as thermal protection for the housing and as thermal protection for a chamber in which the electrical feeds and cooling water pipes are housed. These fiber plates protect the housing from stray radiation still emitted in the direction of the module, despite the gold reflectors in the cooling channels.

### BRIEF SUMMARY OF THE INVENTION

The object of the present invention consists in providing high-power radiation modules having reduced potential for danger.

According to the invention, thermal protection made of inorganic, oxidic material and inhomogeneous with respect to its optical density is arranged between the radiator and housing of a module. The thermal protection according to the invention allows powers per unit contact area of 200 kW/m² and above. High-power radiators with the thermal protection according to the invention are extremely robust and suitable for continuous operation, i.e., the radiator can be operated after completely reaching equilibrium with the surroundings. This equilibrium state is typically set after 5 to 15 minutes.

Fibers are no longer necessary for the thermal protection according to the invention, whereby the potential for danger originating from fiber material is eliminated according to the invention.

Methods described in European patent publication EP 1 159 227 are suitable for the production of a body, in particular a monolithic sinter body, which is suitable as thermal protection, in particular one-piece thermal protection or as a thermal-protection element. In principle, monolithic sinter bodies can be produced by sintering from slurry, such as silica dust slurry.

It has proven effective when for each radiator or double-tube radiator a thermal-protection element or a one-piece thermal protection is used for all of the radiators of a module. In particular:

the thermal protection or each of the thermal-protection elements is a sinter body;

the thermal protection has or the thermal-protection elements have material with grains in the nanometer or micrometer range;

the thermal protection or each of the thermal-protection elements is a monolith;

the material of the thermal protection or the thermal-protection elements has inclusions in the nanometer or micrometer range, for example voids or crystals.

The decisive factor is that the optical density of the thermal protection with respect to IR radiation and optionally with respect to UV radiation fluctuates, particularly is non-uniform in the micro range. For this purpose, small bubbles or dopants have proven effective. In particular, the dimensions of these inclusions are less than 1 mm, preferably less than 100 μm, and especially preferred less than 10 μm.

In a preferred embodiment, the thermal protection, which is optically inhomogeneous with respect to IR radiation, is made of a material transparent for IR radiation, such as quartz glass or Al₂O₃ ceramic. However, fluctuations in the optical density are formed, in particular by different phases within the inorganic, oxidic material, so that these fluctuations with respect to the optical density of the material scatter significant portions of the radiation. Due to its special structure, this material which, according to the invention, is non-uniform in its optical density with respect to IR radiation or optionally UV radiation, does not exhibit energy transfer that would damage the housing in the wavelength range in which a very high transparency would be achieved for a homogeneous and single-phase construction of the material. For quartz glass, depending on the composition and percentage of trace contaminants, this is the wavelength range of 180 nm to 5000 nm. Here, the range of 180 to 400 nm, in particular of 200 nm to 380 nm, is decisive for UV radiators, and the range of 760 to 5000 nm, in particular of 780 nm to 4000 nm, is decisive for IR radiators. This property is achieved through optical inhomogeneity of the quartz glass, such as through targeted and homogeneous introduction of bubbles and interference. Aluminum oxide in pure form exhibits a very good transmission of UV radiation up to approximately 6000 nm. Here, the mentioned property is achieved through a suitable microcrystalline structure of the solid body. It is surprising that the protective shield can be used under conditions that metallic reflectors could no longer withstand, even though the protective shield absorbs more radiation energy or radiation power than reflectors, but the protective shield does not lose its functionality like these reflectors. While the functionality of metallic reflectors depends on their surface area and thus the reflectors also lose their functionality when they are damaged, the functionality of the thermal protection according to the invention is dependent on its thickness, wherein in a broad comparison with the known reflectors, the rustication of the thermal protection increases with its thickness.

High-power radiation modules have proven effective that distinguish themselves in that the thermal protection arranged between the radiator and housing has only one air cooling device for its cooling, wherein, in a preferred embodiment, the air cooling device also cools the radiators. With a simple air cooling, whose energy consumption is negligible in comparison with the radiator power, for example in the one percent or one-tenth of a percent range, with the thermal protection according to the invention, robust high-power radiation modules can be realized having a power per unit contact area of 400 to 600 KW/m². With more complicated cooling systems, powers per unit contact area of greater than 600 KW/m² are possible, wherein even powers per unit contact area of greater than 1 MW/m² can be realized. A simple air cooling is performed, for example by an air stream from a ventilator, a fan, or a radial compressor.

According to one embodiment of the invention, cooling with another process gas, as e.g., nitrogen or argon, is also included. Furthermore, the invention also includes cooling with a stream made of compressed air or another suitable gas, which would not be generated directly by a radial flow compressor, a fan, or a ventilator, but instead indirectly from a pressurized circuit or pressurized containers, as well as any other variant known to one skilled in the art for generating a suitable gas stream.

In one inventive embodiment, the thermal protection is coated on the housing side with gold. This reduces the secondary radiation from the surface of thermal protection that is heated during operation. The emission of the secondary radiation is then performed predominantly from the non-gold-plated radiator-side surface.

The high-power radiation modules equipped with the thermal protection according to the invention do not exhibit degradation of efficiency with increasing operation, as is known for example from high-power radiation modules with water-cooled reflectors.

The inorganic, oxidic material of the thermal protection can be selected from high temperature-stable glasses, in particular quartz glass, as well as from glass ceramics, aluminosilicate or ceramics, in particular aluminum oxide. In particular, pure quartz glass as well as pure aluminum oxide ceramic have proven effective.

According to an embodiment of the invention, radiation protection is provided which, of the radiation power directed toward it, reflects significantly more power in the direction of the irradiating object than it emits and transmits to the module on its rear side. Another decisive factor is that the radiation protection does not heat up enough to self-destruct. With the radiation protection devices according to the invention, it is possible for the first time to provide high-power radiation modules having a power per unit contact area of 200 Watts and far above, also without water or liquid cooling.

Thus, according to the invention, the troubling safety risk with respect to water cooling is eliminated, and the previously experienced enormous expense for minimizing the risks with respect to water cooling is unnecessary.

The radiation protection according to the invention is also suitable for modules having a power per unit contact area between 100 and 200 Watt/m², in particular for the range of 150 to 200 Watt/m² in which considerable demands are made to manage without water cooling.

The radiation protection according to the invention further allows the power per unit contact area on the order of magnitude of 1 MW/m², that could be achieved previously with water-cooled reflectors, to be further increased, in particular for water-cooled modules.

For high-power applications, for example air-cooled modules having powers per unit area above 400 Watt/m², in particular above 600 Watt/m², optically inhomogeneous quartz glass has proven effective as radiation protection, in particular in a composite with gold, in which the optically inhomogeneous quartz glass is directed toward the module front side, i.e., in the direction of the object to be irradiated and the gold is arranged as a layer on the rear side pointing toward the module rear side on the optically inhomogeneous quartz glass. Alternatively, quartz glass ceramics or ceramics glazed with quartz glass are provided, in particular having a gold coating on the rear side.

For some extreme applications, for example air-cooled modules having a power per unit contact area of 100 to 300 Watt/m², in particular 150 to 250 Watt/m², high temperature-stable, optically inhomogeneous glasses are suitable, for example aluminosilicate glasses, borate-silicate glasses, aluminosilicate-borate glasses. In one advantageous embodiment, its rear side is coated with gold or a gold reflector is spaced apart from its rear side.

Air cooling, in which an air stream is directed from the rear side of the module through openings in the radiation protection toward the radiator, has proven effective.

The radiators applied according to embodiments of the invention have a heating filament arranged in a sleeve or a discharge chamber defined in the sleeve. The sleeve advantageously has a tubular or double-tube construction, wherein the tube ends are sealed vacuum tight and have current feedthroughs. The radiation maximum of the radiators preferably lies in the NIR, in particular in the IR-A. The heating filament is preferably made essentially from tungsten or carbon.

For operating high-power heating filaments based on tungsten with emitter temperatures above 2500 K, in particular above 3000 K, according to embodiments of the invention, thermal protection between the sleeve tube of the radiator and the housing holding the radiator is advantageous, in particular for the application of several radiators in a module.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a cross-sectional elevation view through a high-power radiation module according to an embodiment of the invention; and

FIG. 2 is an enlarged detail cross-section of the radiator arrangement of the module from the circled area II of FIG. 1.

### DETAILED DESCRIPTION OF THE INVENTION

The thermal protection 3 is made of an optically inhomogeneous quartz glass according to Heraeus brochure “Opaque Fused Material OFM 970.”

Thermal protection 3 made of optically inhomogeneous quartz glass according to the Heraeus brochure “Opaque Fused Material OFM 970” is coated on the housing side with gold, as this is already carried out in a known way for gold-plated sleeve tubes of infrared radiators.

### Embodiment 1

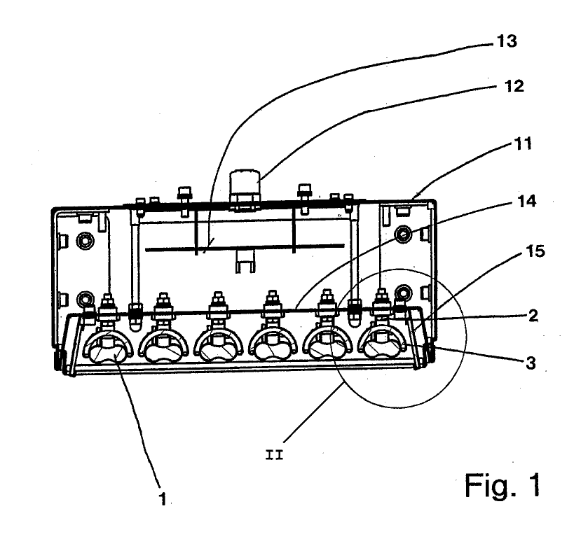

FIG. 1 shows a module having a power per unit area of 400 kW/m², in which six twin tube radiators (1) are arranged in parallel next to each other and are fixed by holding elements (2). The thermal protection elements (3) according to this embodiment of the invention, made of optically inhomogeneous quartz glass, are constructed as half shells and are fixed either in a glass-blowing method on the radiator tubes or by additional holding elements (4) according to FIG. 1. These half shells are arranged so that the individual emitters do not radiate in two directions.

The actual module comprises a housing (11), an inlet opening for air (12), and an impact plate (13), on which the incoming air stream is distributed in the module housing. Between the module inner space and the radiator/thermal protection arrangement, there is a diffusor plate (14). This plate serves first for the mechanical holding of the radiator and reflector, wherein this can also be held at another position in the module. Second, holes or slots, which are used for the optimum formation of the cooling gas stream, are formed in this diffusor plate. For this purpose, holes or slots can be arranged, in particular, in the center behind the individual heat shields. Additional plates (15) made of the thermal protection shield material are arranged as the boundary of the radiator field.

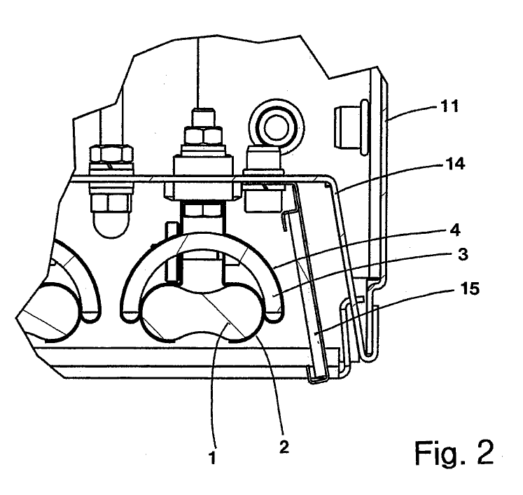

FIG. 2 is an enlarged illustration of a cut-out from FIG. 1. As the thermal protection shield, half shells cut from tubes made of OFM 70 are used (according to Heraeus brochure “Opaque Fused Material OFM 70”), wherein here, many other quartz glasses that are optically inhomogeneous for IR radiation can be used as the starting material.

### Embodiment 2

In a second embodiment having a power per unit area of 550 kW/m², the twin tube radiators arranged in parallel are held at their long, unheated ends and are arranged in front of a plate made of optically inhomogeneous quartz glass plated with gold on the rear side. This plate comprises several segments, in order to keep the production costs low. In the segments, holes are formed at suitable positions, such that the gas made available by suitable devices in the module housing flows out via these holes, so that, first, the radiators are effectively blown against and thus cooled by convection and, second, the still cool gas stream from the housing through the heat shield cools this heat shield. The plates are made of OM100 (according to Heraeus brochure “OM 100 High purity opaque quartz glass”), wherein alternatively, many other optically inhomogeneous quartz glasses can be used as the starting material.

Laterally, for protecting the module, there are additional plates made of OM100, which are cooled by convection on the rear side.

### Embodiment 3

In a third embodiment having a power per unit area of 600 kW/m², the twin tube radiators arranged in parallel are held on their long, unheated ends. The arrangement is like that in Embodiment 2, but the rear-side thermal protection comprises a plate of transparent quartz glass, on which a sufficiently thick layer made of optically inhomogeneous quartz is deposited as a slurry and is later sintered. This layer is oriented in the direction of the infrared radiator, and the rear-side quartz plate is gold-plated. Slots and holes for cooling the heat shield and the radiator are constructed as in Embodiment 2, but the quantity of air for cooling is correspondingly increased.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-14. (canceled)

15. A high-power radiation module, comprising a thermal protection made of inorganic, oxidic material arranged between a radiator and a housing, the thermal protection comprising an essentially fiber-free material that is optically inhomogeneous with respect to IR radiation or UV radiation, wherein the high-power radiation module has a power per unit contact area of at least 200 kW/m2.

16. The high-power radiation module according to claim 15, wherein the thermal protection has only air cooling for its cooling.

17. The high-power radiation module according to claim 15, wherein the thermal protection has a thickness such that it exhibits an IR transmission of less than 10% at a temperature between 0 and 1000° C.

18. The high-power radiation module according to claim 15, wherein the optically inhomogeneous, oxidic material is selected from quartz glass, high-temperature stable glasses, glass ceramics, aluminosilicates, and ceramics.

19. The high-power radiation module according to claim 15, further comprising thermal protection shields guiding a cooling air stream to the radiators.

20. The high-power radiation module according to claim 15, wherein the thermal protection has openings through which cooling air is guided to the radiators.

21. The high-power radiation module according to claim 15, wherein the material of the thermal protection features inclusions.

22. The high-power radiation module according to claim 15, wherein the thermal protection features material comprises grains in a nanometer or micrometer range.

23. The high-power radiation module according to claim 15, wherein the thermal protection comprises a sinter body or has a sinter body for each radiator.

24. The high-power radiation module according to claim 15, wherein the thermal protection is a monolith or has a monolith for each radiator.

25. The high-power radiation module according to claim 15, wherein the module is water-cooled and has a power per unit contact area of at least 600 KW/m2.

26. The high-power radiation module according to claim 25, wherein the power per unit contact area is at least 1 Megawatt/m2.

27. A method for production of a radiation module, the method comprising electrically connecting several radiators or radiation units, mechanically holding the radiators or radiation units in a housing having an outlet opening for emitted radiation, and arranging a thermal protection made of inorganic, oxidic material on a side of the radiators or radiation units facing away from the outlet opening, wherein the thermal protection is optically inhomogeneous and essentially fiber-free.

28. The method for production of a radiation module according to claim 27, further comprising arranging a gold layer between the thermal protection and the housing by housing-side coating of the thermal protection with gold.
